(19) United States
(12) Patent Application Publication
(10) Pub. No.: US 2014/0142818 A1
(43) Pub. Date: May 22, 2014

(54) VEHICLE SPEED CONTROL SYSTEM AND METHOD

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/050,359

(22) Filed: Oct. 10, 2013

(30) Foreign Application Priority Data
Nov. 22, 2012 (TW) 101143633

(51) Int. Cl. G08G 1/052

(52) U.S. Cl. CPC G08G 1/052
USPC 701/51

(57) ABSTRACT

A vehicle speed control method detects a speed of a vehicle by a speed sensor of the vehicle, and determines location information of the vehicle by a global positioning system when the vehicle is driving on a road. The method transmits the location information of the vehicle to a host via a network, and receives speed limit information of the road sent from the host. The method then determines whether the speed of the vehicle exceeds a speed limit range of the road. If the speed of the vehicle exceeds the speed limit range of the road, the controls an automatic gearbox of the vehicle to adjust the speed of the vehicle to fall within the speed limit range.

### BACKGROUND

1. Technical Field

Embodiments of the present disclosure relate to device controlling systems and methods, and more particularly to a vehicle speed control system and method.

2. Description of Related Art

Speeding (driving over the speed limit) may cause traffic accidents. Most vehicles are configured with speedometers. When a driver is speeding in a vehicle on a road, a speedometer of the vehicle can be used to send out a prompt (e.g., voice prompt) to alert the driver. However, sometimes the driver may ignore the prompt and not reduce speed in time, which may result in a speeding ticket or a traffic accident.

### BRIEF DESCRIPTION OF THE DRAWINGS

FIG. 1 is a block diagram of one embodiment of an application environment of a speed control system.

FIG. 2 illustrates road speed limit data stored by a database of a host.

FIG. 3 illustrates hardware components of a vehicle configured with the speed control system of FIG. 1 and function modules of the speed control system.

FIG. 4 illustrates adjusting a speed of the vehicle by the speed control system of FIG. 1.

FIG. 5 is a block diagram of one embodiment of a vehicle speed control method.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

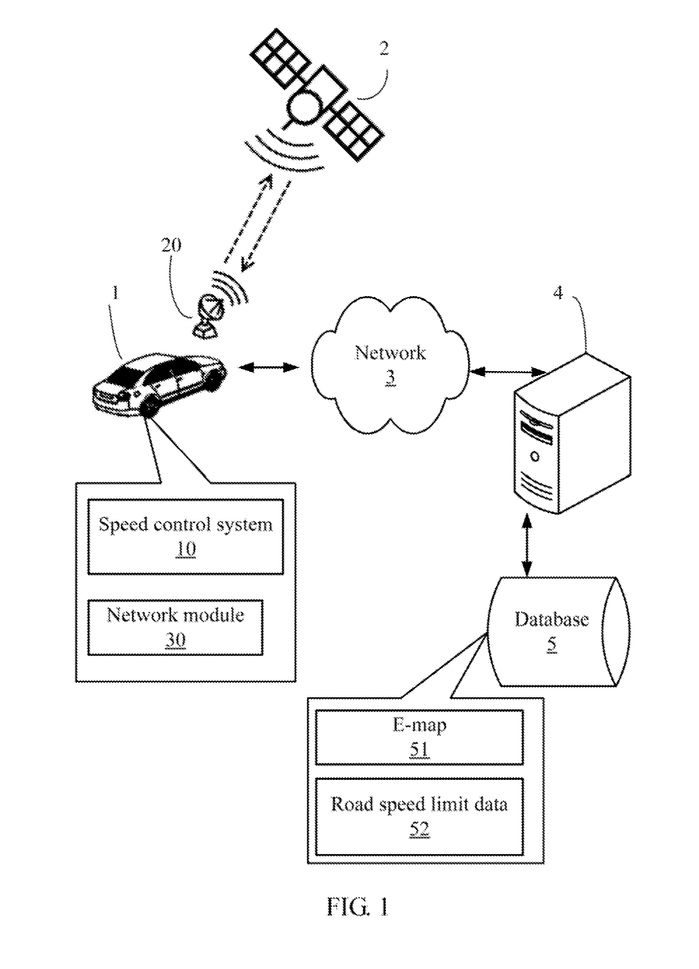

FIG. 1 is a block diagram of one embodiment of an application environment of a speed control system 10. The speed control system 10 is installed in a vehicle 1. The vehicle 1 further includes a global positioning system (GPS) 20 and a network module 30. The GPS 20 provides location information (i.e., longitude and latitude information) of the vehicle 1 according to radio signals transmitted by satellites 2. The speed control system 10 communicates with a network 3 via the network module 30, and transmits the location information of vehicle 1 to a host 4 (e.g., a server) via the network 3. A database 4 is connected to the host 4. The host 4 reads an electronic map (E-map) 51 and road speed limit data 52 from the database 5, determines a position on the E-map 51 where the vehicle 1 is located according to the location information of the vehicle 1, and determines a road where the vehicle is located according to the determined position on the E-map 51. The host 4 then searches speed limit information of the determined road from the road speed limit data 52, and transmits the speed limit information of the determined road to the vehicle 1 via the network 3. The speed control system 10 automatically adjusts a speed of the vehicle 1 according to the speed limit information.

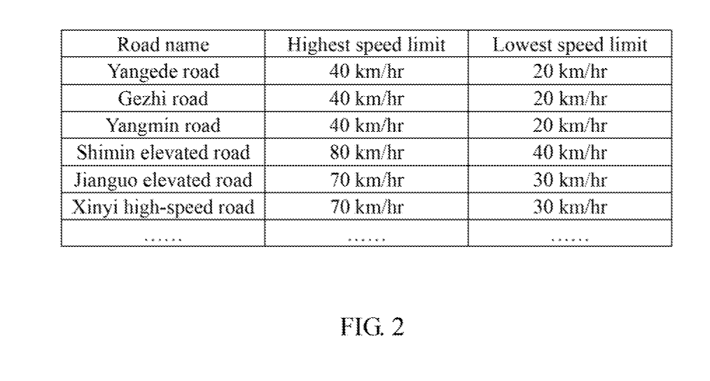

FIG. 2 illustrates the road speed limit data 52 stored in the database 50. The road speed limit data 52, includes road name information in relation to roads of a district (e.g. a province or a country), a highest speed limit and a lowest speed limit of each road.

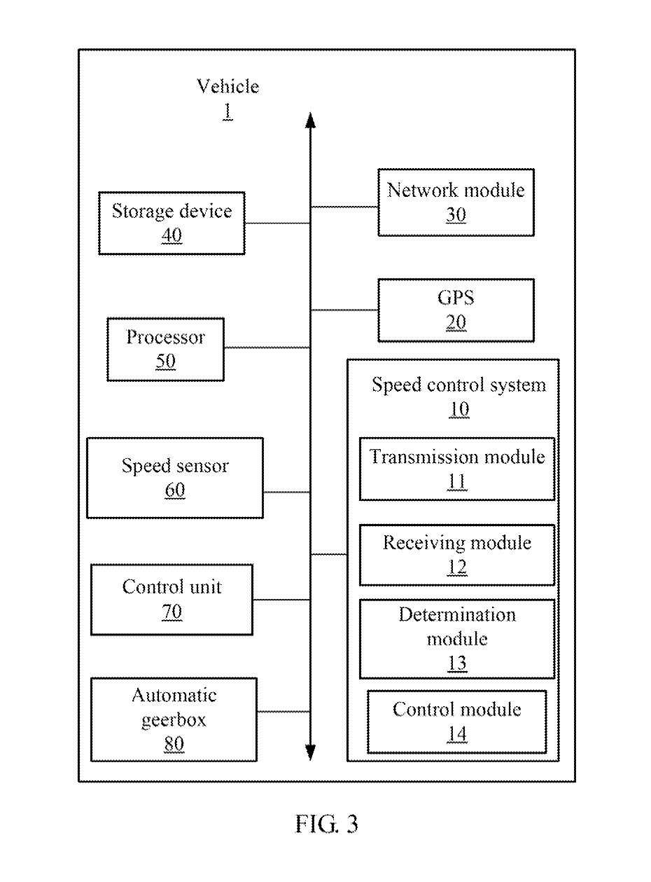

As shown in FIG. 3, the vehicle 1 further includes a storage device 40, a processor 50, a speed sensor 60, a control unit 70, and an automatic gearbox 80. The components 10-80 are connected to each other via a system bus. The speed control system 10 includes a transmission module 11, a receiving module 12, a determination module 13, and a control module 14. The modules 11-14 include computerized code in the form of one or more programs. The computerized code is stored in the storage device 40. The processor 50 executes the computerized code, to provide functions of the modules 11-14 described below. The storage device 40 may be a dedicated memory, such as an EPROM, a hard disk drive (HDD), or a flash memory. In some embodiments, the storage system 40 may also be an external storage device, such as an external hard disk, a storage card, or other data storage medium.

When the vehicle 1 is driving on a road, the speed sensor 60 continuously detects a speed of the vehicle 1, and the GPS 20 continuously determines the location information of the vehicle 1. The transmission module 11 transmits the location information of the vehicle 1 to the host 4 via the network 2. The receiving module 12 receives a speed limit range of the road sent from the host 4. The determination module 13 determines if the speed of the vehicle exceeds the speed limit range of the road. If the speed of the vehicle exceeds the speed limit range of the road, the control module 14 sends a control command to the control unit 70. The control unit 70 controls the automatic gearbox 80 to adjust the speed of the vehicle 1 to fall within the speed limit range.

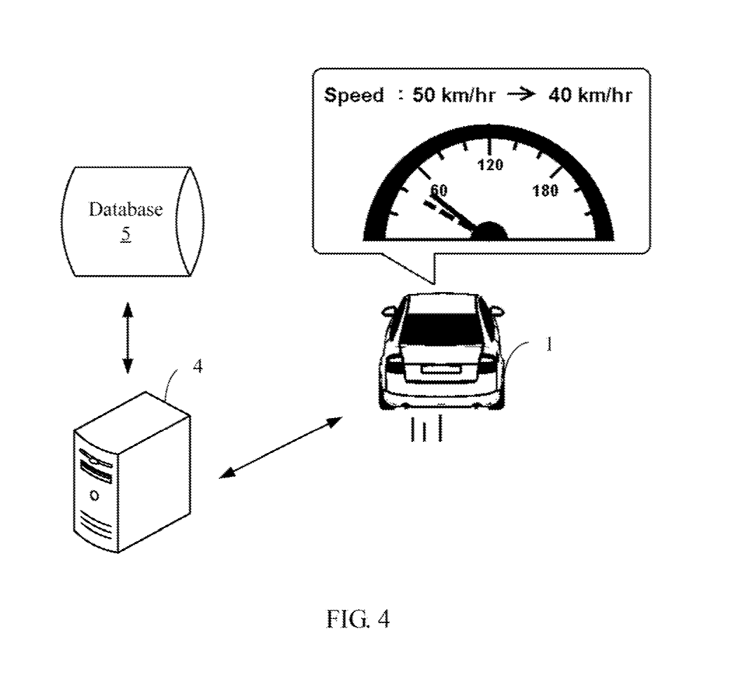

For example, the host 4 determines that the vehicle 1 is located on the “Yangede road” recorded in the table of FIG. 2, then sends the speed limit range [20 km/hr, 40 km/hr] of the “Yangede road” to the vehicle 1. If the speed sensor 60 detects that the speed of the vehicle 1 is 50 km/hr, the determination module 13 determines that the speed of the vehicle 1 exceeds the speed limit range [20 km/hr, 40 km/hr] of the “Yangede road.” Then the determination module 13 activates the control module 14 to send the control command to the control unit 70. Upon receiving the control command, the control unit 70 controls the automatic gearbox 80 to adjust the speed of the vehicle 1 to fall within the speed limit range [20 km/hr, 40 km/hr] of the “Yangede road.” For example, the automatic gearbox 80 adjusts the speed of the vehicle 1 from 50 km/hr to 40 km/hr (as shown in FIG. 4).

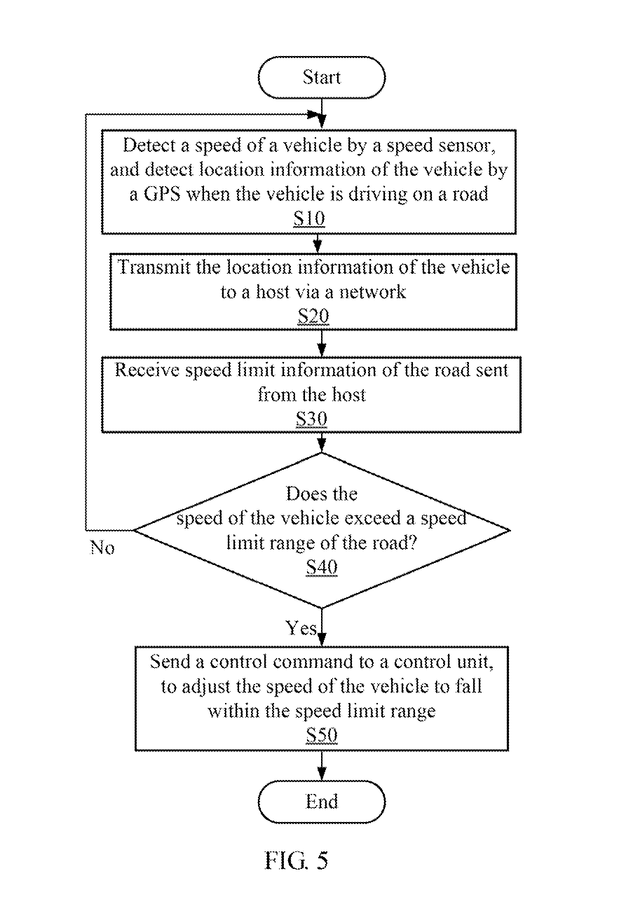

FIG. 5 is a block diagram of one embodiment of a vehicle speed control method. Depending on the embodiment, additional steps may be added, others removed, and the ordering of the steps may be changed.

Step S10, when the vehicle 1 is driving on a road, the speed sensor 60 continuously detects a speed of the vehicle 1, and the GPS 20 continuously determines location information of the vehicle 1.

In step S20, the transmission module 11 transmits the location information of the vehicle 1 to the host 4 via the network 2. The host 4 determines a position on the E-map 51 where the vehicle 1 is located according to the location information of the vehicle 1, and determines the road where the vehicle is located according to the determined position on the E-map 51. The host 4 then searches speed limit information of the road from the road speed limit data 52, and transmits the speed limit information of the road to the vehicle 1 via the network 3.

In step S30, the receiving module 12 receives the speed limit information, which includes a speed limit range of the road, sent from the host 4.

In step S40, the determination module 13 determines if the speed of the vehicle 1, which is detected by the speed sensor 6, exceeds the speed limit range of the road. If the speed of the vehicle 1 does not exceed the speed limit range of the road, the procedure returns to step S10. Otherwise, if the speed of the vehicle 1 exceeds the speed limit range of the road, step S50 is implemented.

In step S50, the control module 14 sends a control command to the control unit 70. The control unit 70 controls the automatic gearbox 80 to adjust the speed of the vehicle 1 to fall within the speed limit range of the road.

Before adjusting the speed of the vehicle 1, the determination module 13 may send a first prompt (e.g., a first voice prompt) to alert a driver of the vehicle 1 that the speed of the vehicle 1 exceeds the speed limit range of the road. In addition, after adjusting the speed of the vehicle 1, the determination module 13 may send a second prompt (e.g., a second voice prompt) to alert the driver of the vehicle 1 that the speed of the vehicle 1 has been adjusted to fall within the speed limit range of the road.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A vehicle speed control method, comprising:
detecting a speed of a vehicle on a road by a speed sensor of the vehicle, and determining location information of the vehicle by a global positioning system;
transmitting the location information of the vehicle to a host via a network, and receiving speed limit information of the road sent from the host, wherein the speed limit information is determined according to the location information and comprises a speed limit range of the road;
determining whether the speed of the vehicle exceeds the speed limit range of the road; and
in response to determining that the speed of the vehicle exceeds the speed limit range of the road, controlling an automatic gearbox of the vehicle to adjust the speed of the vehicle to fall within the speed limit range by sending a control command to a control unit connected to the automatic gearbox.

2. The method as claimed in claim 1, wherein the host stores an electronic map and road speed limit data in a database, and when receiving the location information of the vehicle, the host determines a position of the vehicle on the electronic map according to the location information, determines the road where the vehicle locates according to the determined position, and searches the speed limit information of the road from the road speed limit data.

3. The method as claimed in claim 2, wherein the road speed limit data comprises road name information in relation to roads of a district, a highest speed limit and a lowest speed limit of each road.

4. The method as claimed in claim 1, further comprising:
in response to determining the speed of the vehicle exceeds the speed limit range of the road, sending a first prompt to alert a driver of the vehicle that the speed of the vehicle exceeds the speed limit range of the road.

5. The method as claimed in claim 1, further comprising:
after adjusting the speed of the vehicle, sending a second prompt to alert a driver of the vehicle that the speed of the vehicle has been adjusted to fall within the speed limit range of the road.

6. A vehicle speed control system, comprising:
a processor; and
a storage device that stores one or more programs, when executed by the processor, causing the processor to perform operations:
detecting a speed of a vehicle on a road by a speed sensor of the vehicle, and determining location information of the vehicle by a global positioning system;
transmitting the location information of the vehicle to a host via a network, and receiving speed limit information of the road sent from the host, wherein the speed limit information is determined according to the location information and comprises a speed limit range of the road;
determining whether the speed of the vehicle exceeds the speed limit range of the road; and in response to determining that the speed of the vehicle exceeds the speed limit range of the road, controlling an automatic gearbox of the vehicle to adjust the speed of the vehicle to fall within the speed limit range by sending a control command to a control unit connected to the automatic gearbox.

7. The system as claimed in claim 1, wherein the host stores an electronic map and road speed limit data in a database, and when receiving the location information of the vehicle, the host determines a position of the vehicle on the electronic map according to the location information, determines the road where the vehicle locates according to the determined position, and searches the speed limit information of the road from the road speed limit data.

8. The system as claimed in claim 7, wherein the road speed limit data comprises road name information in relation to roads of a district, a highest speed limit and a lowest speed limit of each road.

9. The system as claimed in claim 6, wherein the operations further comprise:
in response to determining the speed of the vehicle exceeds the speed limit range of the road, sending a first prompt to alert a driver of the vehicle that the speed of the vehicle exceeds the speed limit range of the road.

10. The system as claimed in claim 6, wherein the operations further comprise:
after adjusting the speed of the vehicle, sending a second prompt to alert a driver of the vehicle that the speed of the vehicle has been adjusted to fall within the speed limit range of the road.

11. A non-transitory computer-readable medium having stored thereon instructions that, when executed by a processor of a vehicle speed controlling system, cause the processor to perform operations:
detecting a speed of a vehicle on a road by a speed sensor of the vehicle, and determining location information of the vehicle by a global positioning system;
transmitting the location information of the vehicle to a host via a network, and receiving speed limit information of the road sent from the host, wherein the speed limit information is determined according to the location information and comprises a speed limit range of the road;
determining whether the speed of the vehicle exceeds the speed limit range of the road; and in response to determining that the speed of the vehicle exceeds the speed limit range of the road, controlling an automatic gearbox of the vehicle to adjust the speed of the vehicle to fall within the speed limit range by sending a control command to a control unit connected to the automatic gearbox.

12. The medium as claimed in claim 11, wherein the host stores an electronic map and road speed limit data in a database, and when receiving the location information of the vehicle, the host determines a position of the vehicle on the electronic map according to the location information, determines the road where the vehicle locates according to the determined position, and searches the speed limit information of the road from the road speed limit data.

13. The medium as claimed in claim 12, wherein the road speed limit data comprises road name information in relation to roads of a district, a highest speed limit and a lowest speed limit of each road.

14. The medium as claimed in claim 11, wherein the operations further comprise:
in response to determining the speed of the vehicle exceeds the speed limit range of the road, sending a first prompt to alert a driver of the vehicle that the speed of the vehicle exceeds the speed limit range of the road.

15. The medium as claimed in claim 11, wherein the operations further comprise:
after adjusting the speed of the vehicle, sending a second prompt to alert a driver of the vehicle that the speed of the vehicle has been adjusted to fall within the speed limit range of the road.
